(19) United States
(12) Patent Application Publication
(10) Pub. No.: US 2002/0186254 A1
(43) Pub. Date: Dec. 12, 2002

(54) Information handling method and apparatus and intuitive graphical user interface for navigating business application software

(75) Inventor: Jean-Jacques Monbaron, Fontaines (CH)

Correspondence Address: Nicholas A. Pandiscio, Pandiscio & Pandiscio, P.C., 470 Totten Pond Road, Waltham, MA, 02451-1914, US

(73) Assignee: Apps4biz.com Holding AG

(21) Appl. No.: 09/878,577

(22) Filed: Jun. 11, 2001

(51) Int. Cl. G09G 5/00

(52) U.S. Cl. 345/810

(57) ABSTRACT

A graphical user interface comprising real world metaphors is provided for navigating an information handling method and system. The interface comprises four screens with metaphors (Items, People, Actions, Results) that simplify user interaction and navigation. An improved information handling method and system is provided in which the graphical user interface is combined with a central transactional database and a user-definable workflow technology. The central transactional database table stores all transactions at the line item level, with each record containing information according to four main dimensions (Items, People, Actions and Time). The invention allows users to define action types, to link action types logically, and to trace actual transactions at the line item level according to these linkages as defined at the time the transaction takes place.

### FIELD OF THE INVENTION

The invention relates to business application software and more specifically to a graphical user interface and system for simplifying the interaction between users and business software applications, and also to an improved information handling method and apparatus. The invention involves navigational tools, database structures, work flow technologies and information processing methods.

### BACKGROUND OF THE INVENTION

Even in small businesses, large quantities of data must be managed. Such data, consisting of items, addresses, documents, or processes, is needed for various tasks such as operating management, diagnostics, or technical device management in areas such as bookkeeping, marketing, warehouse management, production planning, etc. This data is stored in databases and processed or managed with computer programs. These computer programs are generally referred to a “business software applications”.

Complex business software applications emerged in the 1960s and 1970s. Sales orders were translated into shop orders by using bills of material. The systems generated optimized manufacturing schedules and inventory management under complex circumstances (a large number of products, each with complicated, multi-tiered bills of material, manufacturing operations with a large number of cells and multiple sequencing possibilities, etc.). Later, these systems were extended to ERP (“Enterprise Resource Planning”) and CRM (Customer Relationship Management) Systems, including functions such as financial management, human resource management, sales, service and support, etc. Recent innovations extend these systems beyond the boundaries of an individual organization, integrating data with key suppliers and key customers (e-commerce type applications).

Early business application systems were entirely based on predetermined verbal and numerical commands. A user accessed information within the computer system (i.e. navigated through the system) by typing commands that instructed the central processing unit to run software programs (i.e. modules within the business application), to change directories and to view directories.

In parallel there emerged personal computer systems using operating systems based largely on graphical user interfaces (GUI). These GUI are exemplified by the Apple Macintosh operating systems and the Microsoft Windows operating systems. These GUIs are based on navigation systems that include iconic representations of files and programs. Certain programs that run on personal computers use physical representations of objects to allow a user to navigate. Examples include the image of a manila file folder or of a notebook separated by dividers. The use of graphical icons is especially prevalent in software games or in educational software. U.S. Pat. No. 5,896,133, issued Apr. 20, 1999 to K. M. Lynch et al. discloses a GUI that uses metaphors of architectural objects to navigate successfully among functions within an extensible range of functionality. In the 1990s, many developers of business applications updated or rewrote their software programs to include GUIs. However, generally those GUIs are based on text icons rather than icons in the form of real-world business metaphors that enable the user to intuitively navigate and control the operations of a business system for the purpose of inputting, accessing, reviewing, analyzing and otherwise manipulating or processing data.

Traditional business software applications suffer from one or more of the following disadvantages:

1. They have a fixed structure that determines the data flow. Consequently adaptations to the individual requirements of a business or to operating developments cannot be undertaken at all, or only with great programming expense. Such programs are therefore inflexible and not very user-friendly. In particular, they force a business to follow a specific procedural method, which often does not optimally match the challenges and/or the specific workflow of the business.

2. Prominent business software applications typically offer solutions which are specific to industries or products, often with the result that they are not universally applicable.

3. Even within a single business, several different programs, each corresponding to a specialized area, may be deployed. For example, a business may employ an accounting program, a warehouse management program, an address management program, and so on, with the result that in some cases employees have to learn to operate several programs, resulting in high training costs. Additionally data transfer from one program to another is complicated, error-prone, and risky.

4. Traditional business software applications face the problem of users having to navigate between hundreds, if not thousands, of screen displays in search of a particular piece of information. The typical navigation route entails following the initial route back to the “top menu”, moving across to a different “module” of the application, and then drilling back down into the detailed information contained in that module. Such hierarchical navigation is time consuming and requires extensive user training.

FIG. 1 diagrammatically illustrates a navigation software system for traditional business applications. Essentially the system has a complicated menu tree, with a first level typically consisting of separate screens and/or menus for accounts payable (A/P), finance, order entry, inventory, etc., secondary lower levels consisting, for example, of separate screens for vendors and customers, and other more lower level screens, many with different look, feel and layout, for inputting, accessing and displaying different information according to the selected first level branch. Further with respect to use with a navigation system as illustrated in FIG. 1, traditional business software applications have database structures that are generally characterized by a multitude of tables. A customer order may be captured initially in an “open orders table”. At a given time, these customer orders may be “posted” to the system, which will either assign inventory to these orders, or generate manufacturing shop orders. Once posted, the open orders are deleted, and some (but not necessarily all) information is transferred to other database tables within the system. This database structure makes it difficult to aggregate information. For example, if a sales representative would like to get an overview of all the information relevant to a given customer, he may be interested in open orders, past invoices, collection history, support calls, marketing materials mailed, and returned items. In traditional business software applications, this information is almost always stored in different database tables. Aggregation on an ad hoc basis is extremely time consuming and requires deep understanding of each aspect of the application. Aggregation in the sense of a pre-programmed system capability is handicapped in terms of timeliness (i.e., not up to date), as well as being extremely costly, user-specific and rigid.

To supplement this need to aggregate information to facilitate decision making by executives and other officials, companies have started to use Executive Information Systems (EIS). The latter type of system, which is separated from the entire suite of other operational software, involves storing information from a number of different sources in a central EIS database. Often, this database structure includes a number of dimensions (e.g. geography, customers, products, time), allowing the user to “slice and dice” the data along different dimensions. As an example, a subset of the information contained in a database table “Completed Product Sales Orders” may be transferred to an EIS database table. This data may be completed by similar information from another source containing “Service Contract Revenue” data. This approach is often referred to as OLAP (on-line analytical processing). The drawbacks of OLAP databases (and the EIS which often use OLAP databases) are that data has to be transferred from the original database to the OLAP database, and that the data transferred is often summarized, represents only a subset of the transactional data, or is only updated at irregular intervals. Furthermore, data in EIS is always summarized (e.g., all orders for a given customer in a given month), and not presented at the transaction level. Therefore, EIS/OLAP systems do not provide a single, unified view of all transactions with one customer.

Since OLAP databases are sparsely populated, they are well suited for analytical purposes. On the contrary, relational databases are generally used for business transactions in traditional business software applications since they contain a richer set of data. The name “relational” comes from the fact that, for example, a table for orders may contain an item code, establishing a relationship to an item table. This item table in turn may contain a cost code, establishing a relationship to yet another table.

The philosophy of storing a large number of records in a central transactional database goes contrary to the philosophy of most traditional business software applications. The traditional database design philosophy was born out of the early constraints of computing systems where disk space, memory and processing power was scarce and expensive, and thus transactional database structures had to be reduced to the absolute minimum. With the progress in speed, memory and processing power made over the course of the last 30 years, this is no longer a constraint. Extending the amount of information contained in a central table takes advantage of this increased processing power and delivers innovative benefits in terms of speed, user-friendliness, traceability and analytical power.

### OBJECTS AND SUMMARY OF THE INVENTION

The primary object of this invention is to overcome or avoid the foregoing drawbacks of existing business software applications.

Another object is to provide a method and system for simplifying the interaction between users and business software applications.

A further object is to provide a novel and improved system and method for navigating and controlling the operation of business application software.

Still another object is to provide a system and method for intuitively and quickly navigating complex business application software.

An additional object of the invention is to provide a system and method for navigating and controlling business application software that assures that each action entered by the user automatically updates the system, so that accessed information is always up to date.

A further object is to provide an improved information handling method and apparatus.

Another additional object is to provide a software system and method that allows companies to define business processes and incorporate them into the system.

A more specific object is to provide a simple and intuitive GUI for accessing, navigating and operating business software that simplifies the interaction between users and the business software, and substantially reduces training time and training costs and also the time required to navigate the business software for the purpose of entering, accessing, or processing data.

The foregoing objects are achieved by combining three methodologies, namely: (1) a simple and intuitive graphical user interface using real-world business metaphors for navigating and controlling operation of business software applications; (2) one main transactional database table in which all transactions are stored at the line item level, with fields containing information on the four main business dimensions (Items, People, Actions, and Time); and (3) a method for defining a universal schema for managing data, that allows the user to program into the universal schema its company-specific work processes (“workflows”). The workflow technology comprises two database tables, allowing users to define different types of actions, to link them together logically, and trace business transactions according to those linkages. Thus the two database tables describe a “graph” structure.

Other features, advantages and benefits of the invention are described or rendered obvious by the following detailed description which is to be considered together with the accompanying drawings.

### BRIEF DESCRIPTION OF THE DRAWINGS

FIG. 1 is a diagrammatic illustration of a navigation system in accordance with traditional business software applications (Prior Art);

FIG. 2A is a diagrammatic representation of the apparatus required when an information handling method embodying the invention is adapted for a direct connection between one or more users (clients) and a server that comprises stored databases, including the main transactional database;

FIG. 2B is similar to FIG. 2A except that it illustrates the apparatus required for indirect connection;

FIG. 2C schematically represents that the software that implements the invention is structured into three tiers;

FIG. 3A is a schematic illustration of a database structure having a star schema;

FIG. 3B is a schematic illustration of the database structure embodied in the present invention;

FIG. 4 is a diagram of a GUI navigation system in accordance with the present invention;

FIG. 5 schematically illustrates the type of utilities that may be incorporated into a system embodying the present invention;

FIG. 6 illustrates a portion of an overall flowchart of a system embodying the invention;

FIG. 7 is a continuation of the flowchart of FIG. 6 in relation to “Items”;

FIG. 7A is an example of the desk-top screen presentation of the graphical user interface of the present invention depicting the screen for “Items”.

FIG. 8 is a continuation of the flowchart of FIG. 6 in relation to “People”;

FIG. 8A is an example of the desk-top screen presentation of the graphical user interface of the present invention depicting the screen for “People”;

FIG. 9 is a continuation of the flowchart of FIG. 6 in relation to “Actions”;

FIG. 9A is an example of the desk-top screen presentation of the graphical user interface of the present invention depicting the screen for “Actions”;

FIG. 9B is a schematic representation of inputting a new “Action” into the same system;

FIG. 10 is a continuation of the flowchart of FIG. 6 in relation to “Results”;

FIG. 10A is an example of the desk-top screen presentation of the graphical user interface of the present invention depicting the screen for “Results”;

FIG. 11 is a graphical view of an exemplary business process; and

FIGS. 11A and 11B show how two linked database tables can represent the business process of FIG. 11 in a software system according to the invention.

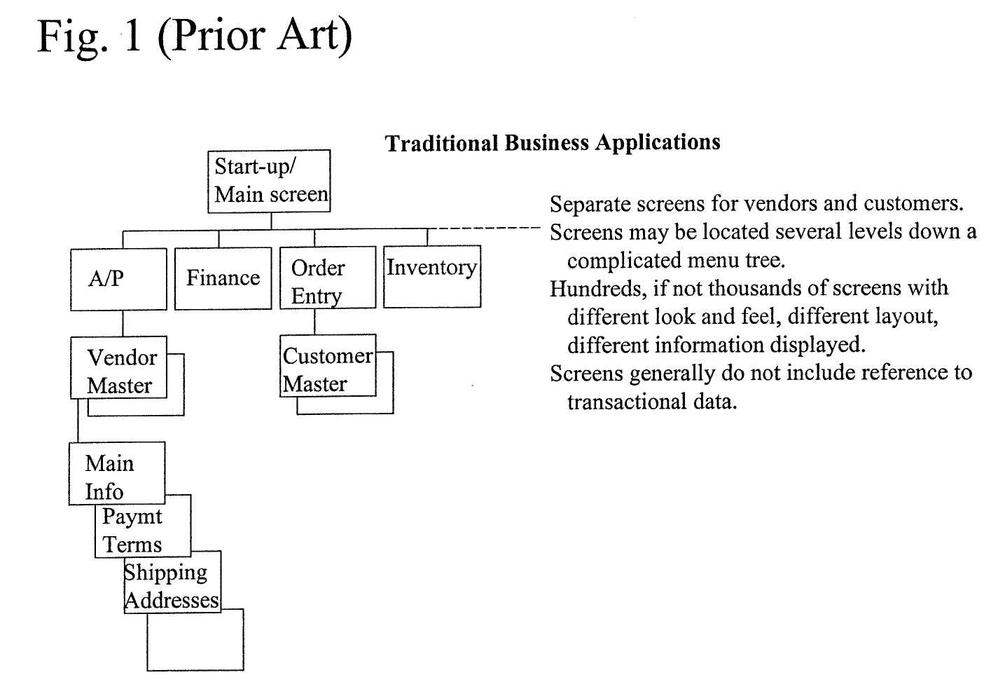

In the several figures, like alphanumeric characters are used to designate like components and functions.

### DESCRIPTION OF THE INVENTION

The present invention provides a simple and intuitive graphical user interface (GUI) based on four screens identified by real-world business metaphors (Items, People, Actions, and Results) for system navigation purposes. Additionally it combines that graphical user interface with two other methodologies, namely, (1) a main transactional database at the line item level with fields containing information on the main business dimensions of Items, People, Actions, and Time, and (2) a workflow technology, i.e. a universal schema for managing data, which allows users to define actions, link them together logically, and trace business transactions according to these linkages. Each action entered in the database automatically updates the entire system. As result, by means of the present invention a user of complex business software applications can, with minimum training, navigate quickly, analyze up-to-date results easily, and define and trace business processes successfully.

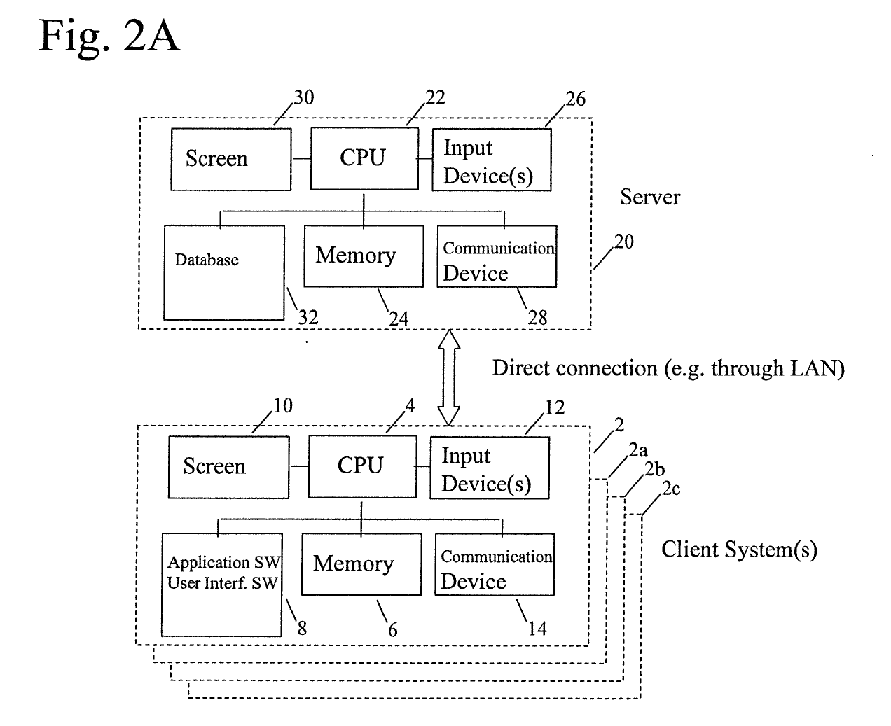

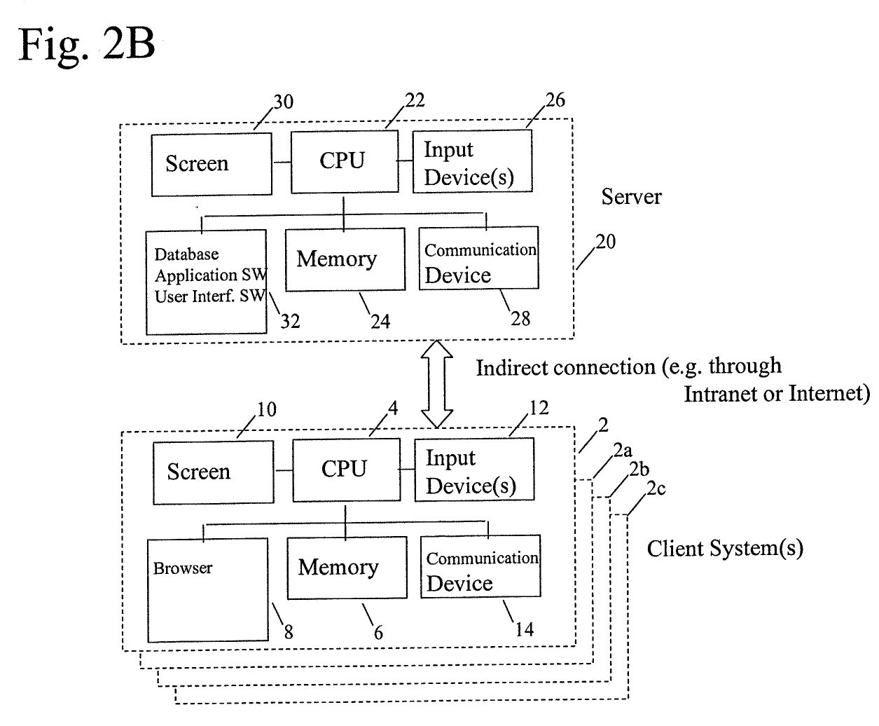

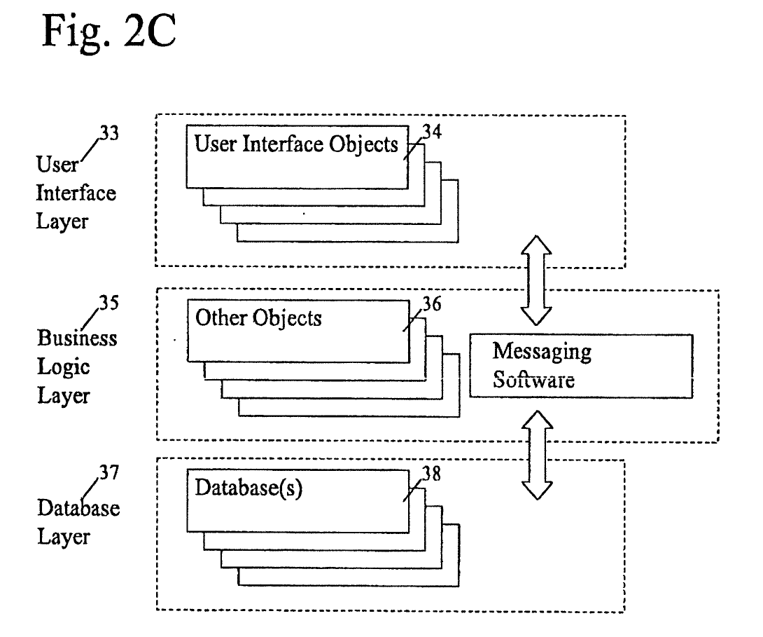

FIG. 2A illustrates one form of apparatus that embodies and is used to practice the present invention. In FIG. 2A, a personal computer 2 is provided which comprises a central processing unit (CPU) 4 that is coupled to memory 6 which may comprise random access memory as well as non-volatile memory and serves to store software for operating the computer, application memory 8 which stores applications software for manipulating data and also graphical user interface software (GUI) for providing a graphical user interface according to the invention to a display device 10. The applications software for manipulating data may comprise one or more conventional programs, e.g., programs for reading and writing data, sorting data, performing search functions, setting printer drivers, and various other utilities relating to data manipulation commonly found in computer systems. Such programs are well known to persons skilled in the computer science and, therefore, they need not be disclosed in detail herein. The display device may take various forms, e.g., a CRT-type monitor or a liquid crystal display (LCD). The display device may be a touch sensitive device which provides signals to the CPU when the screen is touched, with the signals including signals indicative of the coordinates of the location where touching occurred. In such case, the display device has the dual function of a display means and a position locator or selector. The computer 2 also includes an input device 12 for (a) accessing and navigating software and (b) inputting and manipulating data, and a communications device 14 for communicating with a server 20. The input device may take various forms known to persons skilled in the art, e.g., a keyboard, scanner, modem, digital wireless receiver, and/or position locator devices, including but not limited to, a mouse, trackball, thumbwheel, joystick and scan line-sensitive stylus.

Still referring to FIG. 2A, in the illustrated embodiment, server 20 is connected directly to computer 2, e.g., via a local area network (LAN). In such case the server comprises a CPU 22, a systems memory 24 containing software for operating and controlling the server, one or more input devices 26, a communication device 28 that can communicate with communication device 14, a display device 30, and non-volatile memory 32 that stores a central (main) transactional database. Display device 30 is not essential to server 20, since information contained in or generated by the server may be displayed using display device 10. As described hereinafter, in accordance with this invention, the database stored in memory 32 contains records of all business transactions entered on a line item basis.

FIG. 2B illustrates another form of apparatus that embodies and is used to practice the invention. In this case, the computer 2 is unchanged except that it is adapted to communicate with the server 20 through an indirect connection such as an intranet or the Internet. Accordingly the memory 8 stores a browser software which may take various forms, e.g., Microsoft Explorer or Netscape Navigator, and the memory 32 of the server contains the transactional database and also the applications software for manipulating data and the graphical user interface software (GUI) for providing a graphical user interface according to the invention. The applications software and the GUI are accessed via the browser.

Further with respect to FIGS. 2A and 2B, it is to be understood that a variable number of computers may be provided for communicating with server 20, as represented schematically at 2a, 2b and 2c.

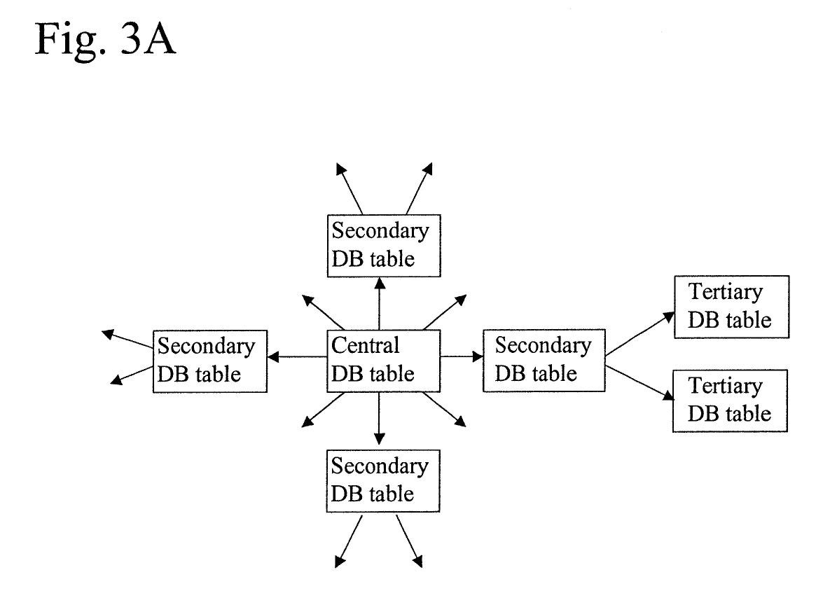

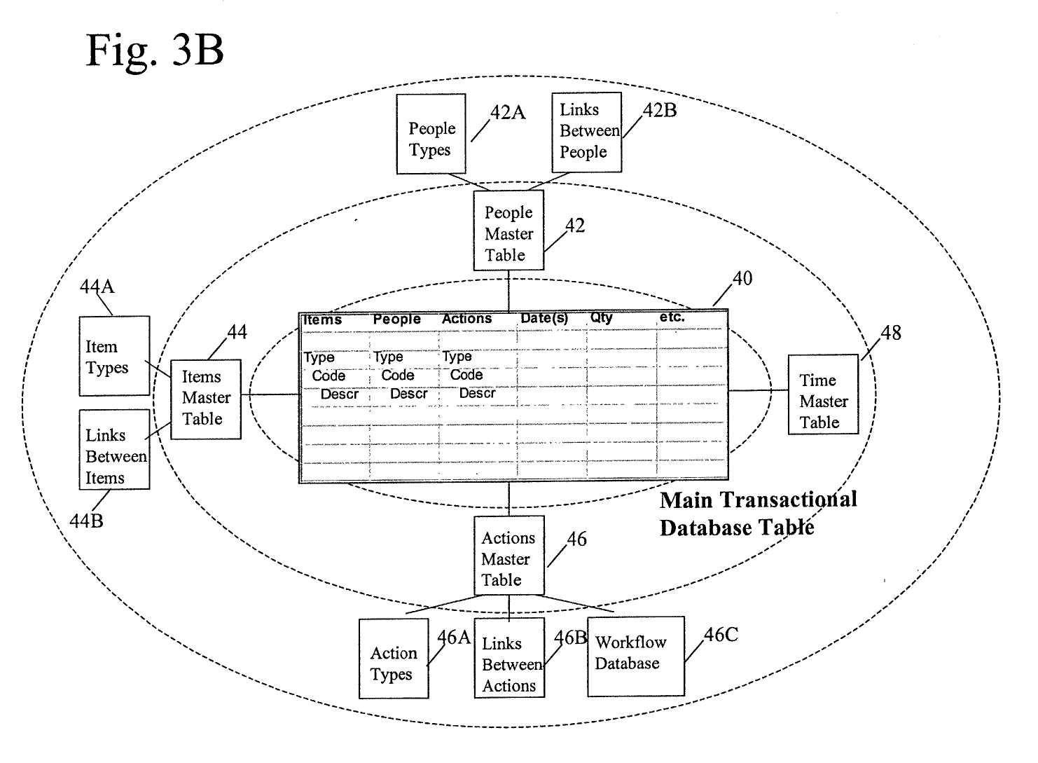

The software that implements the invention is structured into three tiers: a user interface layer, a business logic layer, and a database layer. The user interface layer comprises structured programs and data (or “Objects”) that correspond to the main screens described hereinafter and that enable the user to perform the program activities in those screens. The business logic layer consists of additional Objects that perform key business functions, such as manufacturing planning. Examples of the latter are shortage manager programs and programs for defining structured bills of materials. The business logic layer also includes general Objects that allow the user to print reports, define and manage currencies, summarize date in EIS, define options or analyze history. Finally the database layer comprises a number of different databases and/or database tables, as described hereinafter (see FIG. 3B). To implement the database layers, commercially available software, e.g., Microsoft's Sequel Server or software from other sources, may be used. In addition, messaging software, mainly residing at the business logic layer, enables the program to pull data from the database, display this data in the user interface, process newly entered information and store that processed information in the database. Further details of those Objects are omitted since such constructs are well known to persons skilled in the art.

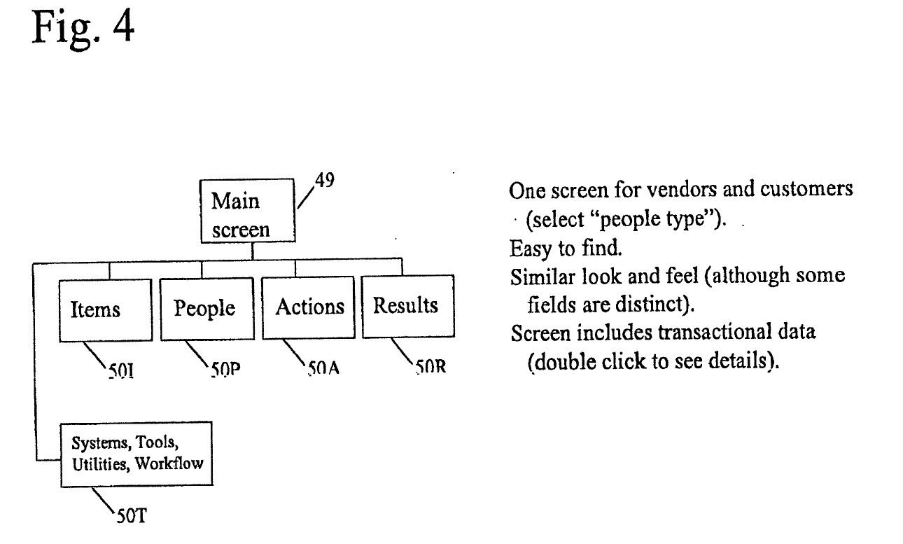

Proceeding now to FIGS. 3 and 4, the invention recognizes and is based on and takes advantage of the fact that the fundamental dimensions or characteristics that define a business transaction are items, people, actions, and time. More specifically, each transaction has to involve an item, whether physical (an actual product which is being designed, manufactured or sold) or not (e.g. a service such as a support call, an hour of consulting, etc.). Each transaction also has to involve a business partner or participant, whether a person or organization, whether internal or external. Also a number of inherently different steps are involved in order to complete a transaction, some of them very general (order, shipment, invoice) and some of them very unique and special to a given business. Finally, each transaction occurs at a given time or within a given period.

The proposed invention essentially combines the benefits of a relational database with those of an EIS using an OLAP database by incorporating a central (main) transactional data base having a star schema design as illustrated in FIG. 3A that comprises a central transactional data base table which is linked to secondary data base tables which in turn are linked to tertiary tables. More specifically, as shown in FIG. 3B, the invention comprises a database schema that includes a central transactional database table 40, with each record in the database containing information on the basis of the four main dimensions of Items, People, Actions and Time. All transactions are stored at the line item level in one main transactional database table, rather than a multitude of separate tables for different transaction types. Of course, each record may contain other relevant information that may be used to further characterize a transaction. Only one main transactional database exists for each system embodying the present invention.

In keeping with the star schema illustrated in FIG. 3A, the central database table 40 has links (relationships) to secondary database tables, notably, master tables 42, 44, 46 and 48 for people, items, actions, and time, and master tables 42, 44 and 46 in turn have further links to tertiary tables in the form of table 42A for types of people and table 42B for links between people, table 44A for types of items and table 44B for links between items, table 46A for type of actions, table 46B for links between actions (i.e., the possible workflows), and table 46C for individual workflow database table (i.e., the actual workflow).

While software applications may exist which have used star schemas in their database design, the use of a star schema transactional data base in accordance with the present invention is essentially a precondition enabling use of a simplified graphical user interface as herein described.

Referring to FIG. 4, the present invention provides a navigation software system in the form of a graphical user interface (GUI) which is programmed so that on start-up it presents a screen 49 that comprises four distinct icons in the form of real-world business metaphors, namely: Items icon 50I, People icon 50P, Actions icon 50A, and Results icon 50R, plus a Tools icon 50T. As described in greater detail hereinafter, selecting the Items icon provides access to physical or non-physical elements, such as products, services or resources. Selecting the People icon provides access to identifying and descriptive information of business participants whether real people or organizations, e.g., customers, employees, vendors, state and federal agencies, and the like. Selecting the Actions icon provides access to activities which are performed between and/or within a business or organization and are driven by a dynamic, rules-based workflow engine or protocol, e.g, activities involving orders or invoices. Selecting the Results icon provides access to detail and summary views of key business metrics, for example sales year-to-date, or inventory levels at a given date. Selecting the Tools icon provides access to utilities software as described hereinafter.

As previously stated, each business transaction can be defined in its most generic level by four parameters: Items, People, Actions and Time. The first three of these parameters translate very directly in business application software programs: they represent functions that need to be performed and sets of data that need to be entered. The fourth parameter, Time, translates only indirectly to a business application. However, it is the fundamental driver of the Results of a business. All results are time sensitive, whether they are sales over a period of time, or inventory value at a given date. Thus, the four parameters of a business transaction (Items, People, Actions and Time) translate into four generic business metaphors and four main icons in the method and system of the present invention (Items, People, Actions and Results).

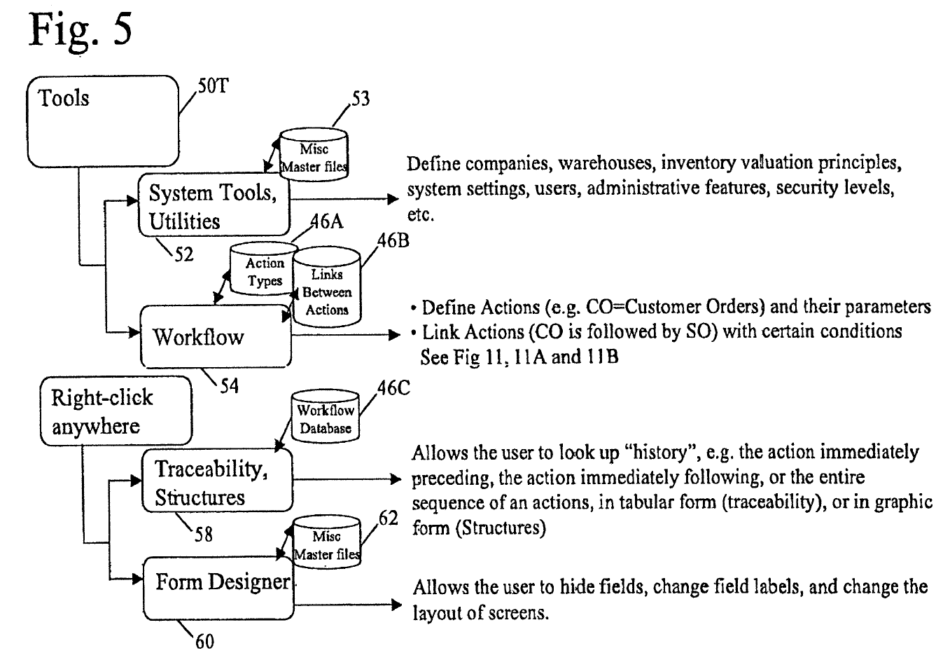

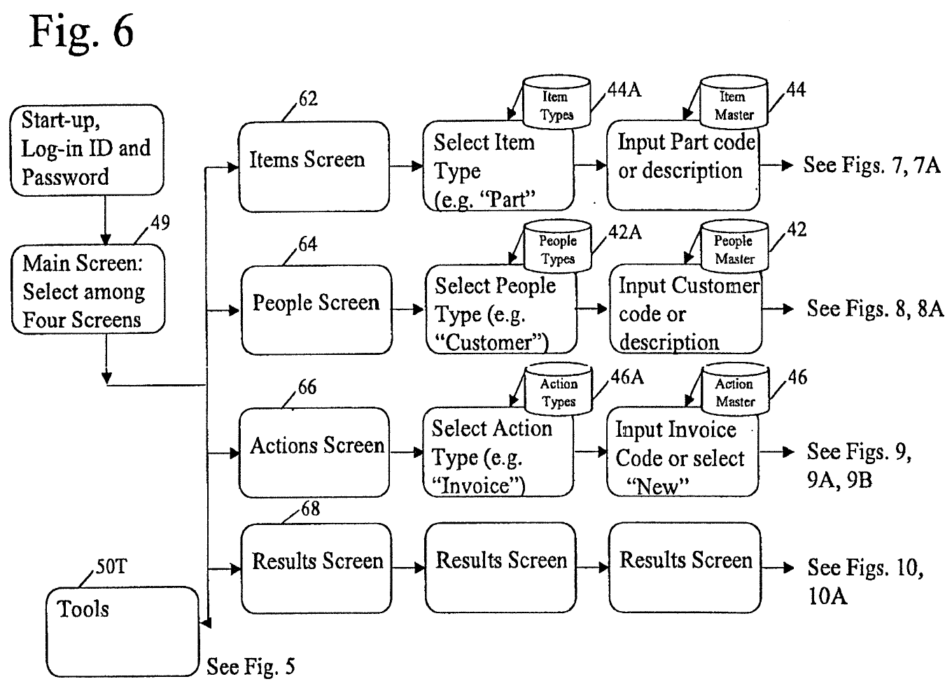

Referring to FIG. 5, the information handling method embodying the navigation system of FIG. 4 requires software comprising utilities for managing data, defining parameters, and allowing the user to program company-specific work processes (workflow) into the system's universal schema for managing data. As represented schematically in FIG. 5, selecting the Tools icon 50T allows the user to access a group of “Systems Tools, Utilities” programs 52 that in turn accesses miscellaneous master tables 53 that permit the user to define such items as system settings, users, security levels, administrative features, companies, warehouses, accounting and inventory valuation principles and the like. Selecting the icon 50T also provides access to a “Workflow” program 54 that allows the user to access Action Type tables 46A and Links Between Actions tables 46B, and to use data from those tables to define actions and their parameters and to link selected actions together, with or without certain conditions, to define a workflow. How the icon selection is effected depends on the system's input device. By way of example but not limitation, the icon may be selected by left-clicking a mouse.

Also, as indicated in FIG. 5, from anywhere in the application, the user can access through a certain input (e.g., the right clicking of a mouse) a “Traceablility” program 58 and a Form Designer Utility program 60. The program 58 is adapted to access workflow database table 46C and to process data from that database to determine the activity “history”, e.g., to determine the action immediately preceding or following a particular action or to show an entire sequence of actions and to arrange the history in tabular form or in graphic form as may be desired by the user. Additionally, the program 50 may include or permit access to designer utility software 60 which allows the user to change the layout of individual screens, change field labels, hide or move fields, and execute other actions related to data presentation. Details of programs 58 and 60 are not provided since such programs are well known to persons skilled in the art.

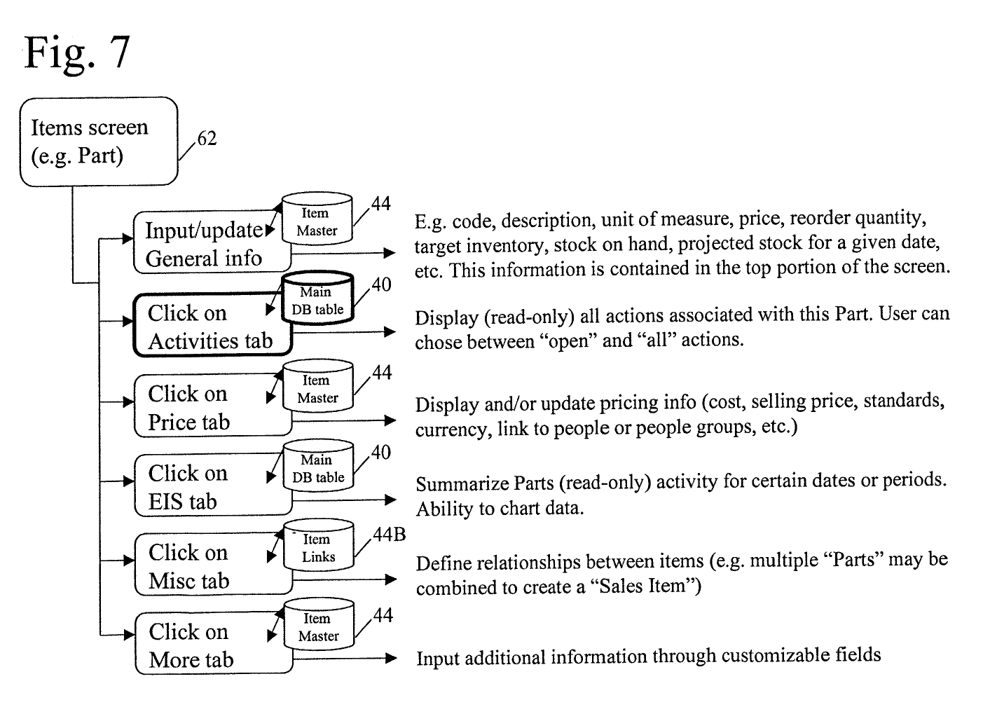

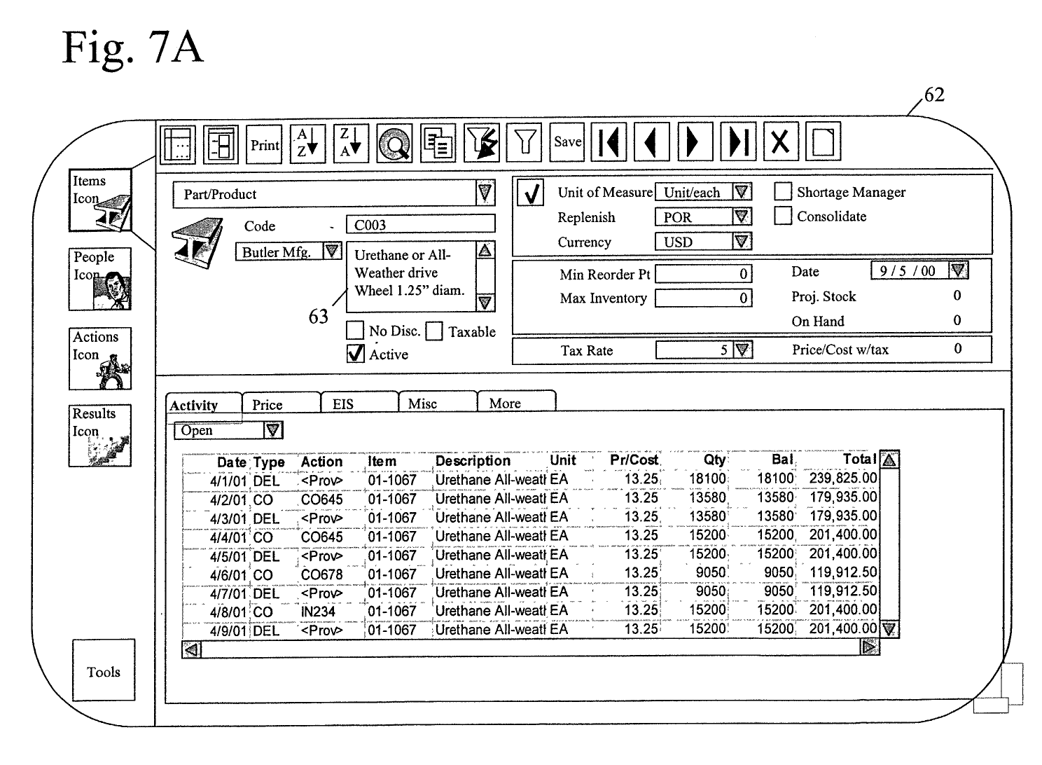

FIGS. 6-10 provide an overall flowchart of operation of the information-handling system using the intuitive graphical user interface (FIG. 4) to navigate the system. After completion of a start-up procedure that preferably involves user identification and password validation, the software system provides the screen display 49 comprising Items icon 50I, People icon 50P, Actions icon 50A, and Results icon 50R, and also the Tools icon 50T, any of which icons may be selected by the user. Preferred designs of the Items, People, Actions and Results icons are presented in FIGS. 7A, 8A, 9A and 10A. Selecting the Items icon results in display of an Items screen 62. Similarly selecting the People, Actions and Results icons results in displays of People screen 64, Actions screen 66, and Results screen 68 respectively. Selecting the Tools icon provides access to the System Tools, Utilities, Workflow programs represented in FIG. 5.

As shown in FIG. 6, selecting Items screen 62 allows the user to select a particular item type and input or select an item description or code. This process involves accessing Item Master table 44 and Item Types table 44A. FIG. 7 illustrates further aspects of the system flow chart in relation to Items screen 62 and is to be considered together with FIG. 7A which shows a typical Items screen. Item selection may be facilitated by providing a dropdown or scrolling list of items as indicated at 63 in FIG. 7A and allowing the user to click on a selected item Alternatively the user may select an item by inputting its description or item number if known.

Items screen 62 provides the user a number of options. One option involves access to item master table 44 and permits the user to input or update general item information, such as item code number, item description, unit of measure, price, reorder quantity, target inventory, stock on hand, projected stock for a given date, and other like information. Such information is contained in a selected portion of Items screen 62. Preferably, but not necessarily, as illustrated in FIG. 7A, this information is contained in the top portion of the screen. Other options are provided by different tabs on Items screen 62. One option is an Activities tab which accesses the main transactional database 40 and commands a read-only display of all actions associate with a selected item, e.g., a particular part. This Activities tab may access a menu that allows the user to choose between “open” actions and “all” actions. As used herein the term “open actions” means actions that require a subsequent action that has not yet been completed. For example, a customer purchase order for an item that has not been followed by a shop order to manufacture the same is considered to be an “open” customer purchase order.

Still referring to FIGS. 7 and 7A, Items screen 62 also includes a price tab that accesses the item master table 44 and enables the user to update and/or display various price information such as cost, selling price, currency, standards, link to people or people groups, etc., and also an EIS tab that accesses the main transactional data base 40 and EIS software which permits summarizing item activity for certain dates or periods and has the ability to chart the summarized data. Items screen 62 preferably includes two additional tabs identified as “Misc.” And “More”. The Misc. tab accesses the Item Links table 44B and permits the user to define relationships between items. For example, a number of different items or parts may be combined to create a particular sales item. The More tab accesses Item Master Table 44 and permits the user to input additional information through customizable fields.

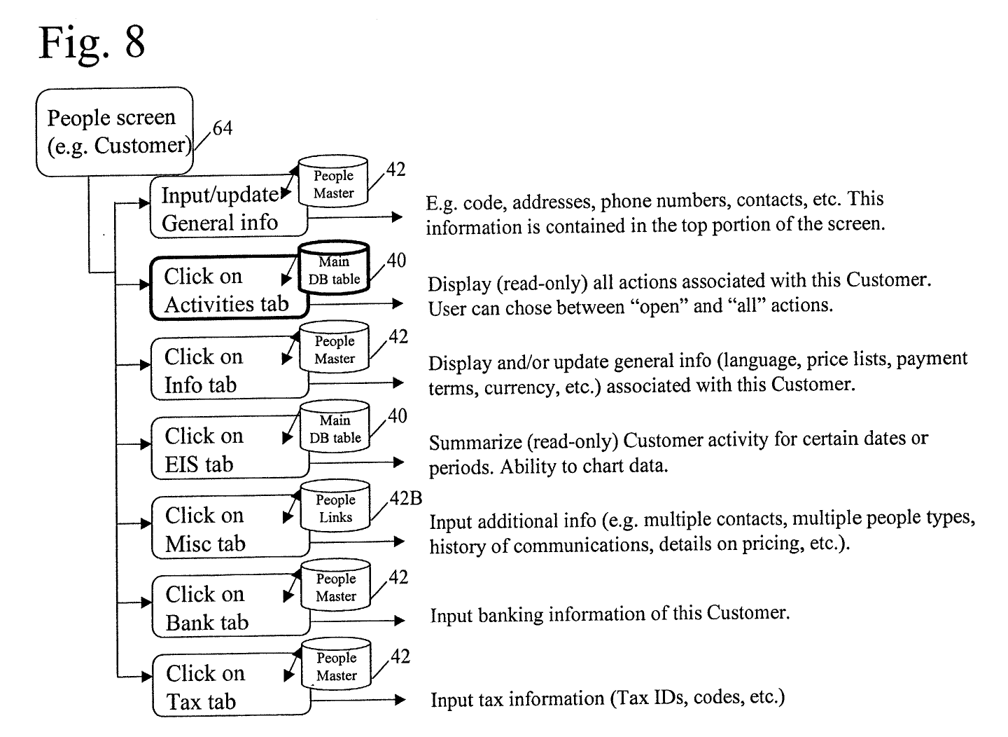

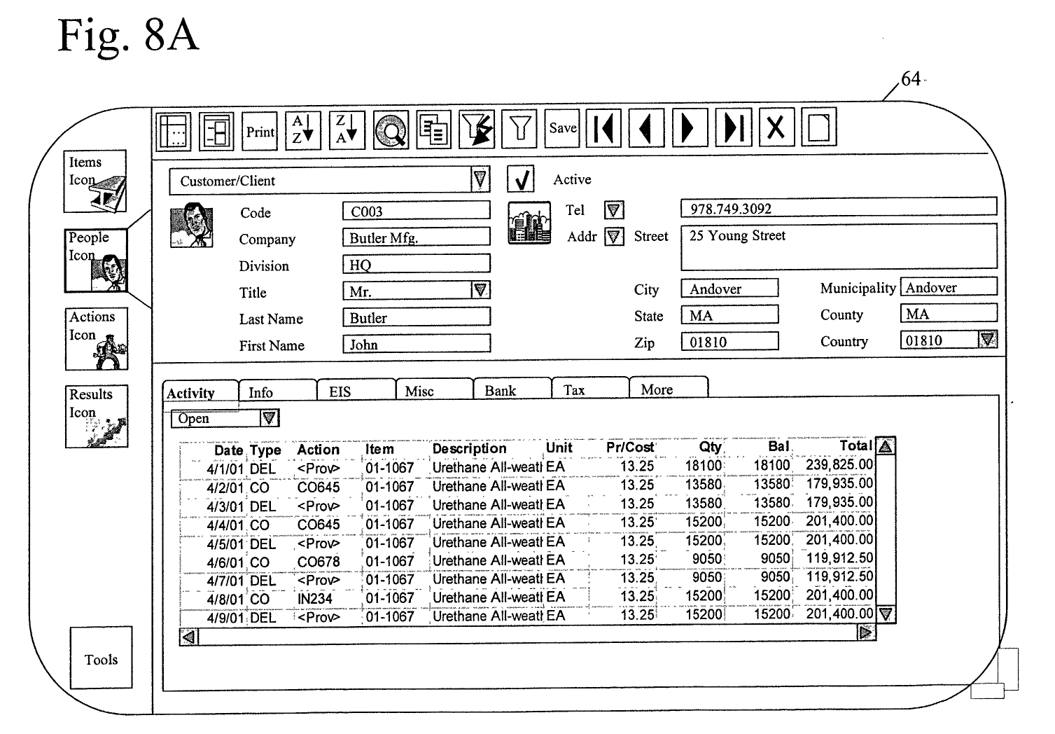

Referring again to FIG. 6, clicking on the People icon allows the user to select a particular People type and input or select a People description or code, e.g., a customer code or description. This process involves accessing People master table 42 and People Types table 42A. FIG. 8 illustrates further aspects of the system flow chart in relation to People screen 64 and is to be considered together with FIG. 8A which shows a typical People screen. People selection may be initiated by inputting a name or identifying number, e.g., vendor or customer number, and may be facilitated by providing a menu or list of different People and allowing the user to click on a selected customer, vendor, etc.

In addition to selecting people by type and selecting specific parties, e.g., customers, vendors, etc. for data processing, the People screen 64 provides the user a number of options. One option involves accessing People Master table 42 and permits the user to input or update general people information such as people code, addresses, telephone numbers, contacts, etc. Such information is contained in a selected portion of the People's screen 64. Preferably, but not necessarily, as illustrated in FIG. 8A, this information is contained at the top of the screen.

Other options are provided by different tabs on the People's screen 64. One option is an Activities tab. Selection of that tab accesses the main transactional data base 40 and commands a read-only display of all actions associated with the selected person or party, e.g. customer. This Activities tab may access a menu that allows the user to choose between those actions that are currently open and all actions whether or not completed relating to the selected person or party.

Still referring to FIGS. 8 and 8A, People screen 64 also includes an information (“Info”) tab that accesses the People Master table 42 and enables the user to display and/or update general information associated with a particular customer, vendor or other person or party, e.g. price lists, payment transactions, language, etc. The People screen also includes an EIS software tab which accesses EIS software and uses the latter to (a) obtain data relating to selected activities for selected People and/or certain dates or periods, and (b) summarizes and charts the data according predetermined and/or use-specified criteria.

People screen 64 also preferably includes three additional tabs identified as “Misc.”, “Bank”, “Tax”, and “More”. The Misc. tab accesses People Links table 42B and permits the user to input additional information to that database regarding anything relating to the selected person, e.g. multiple contacts, multiple people types, history of communications, details on pricing, etc. The Bank tab also accesses the People master table 42 and is used where it is desired to input or access banking information relevant to a particular person, e.g. customer, vendor, etc. The Tax tab also accesses the People master table 42 and permits the user to input relevant tax information such as Tax ID's, tax codes, etc. The “More” tab accesses People Master Table 42 and permits the user to enter additional information through customizable fields. Like FIG. 7a, FIG. 8a illustrates a typical display of information that is accessed by clicking on the Activity tab.

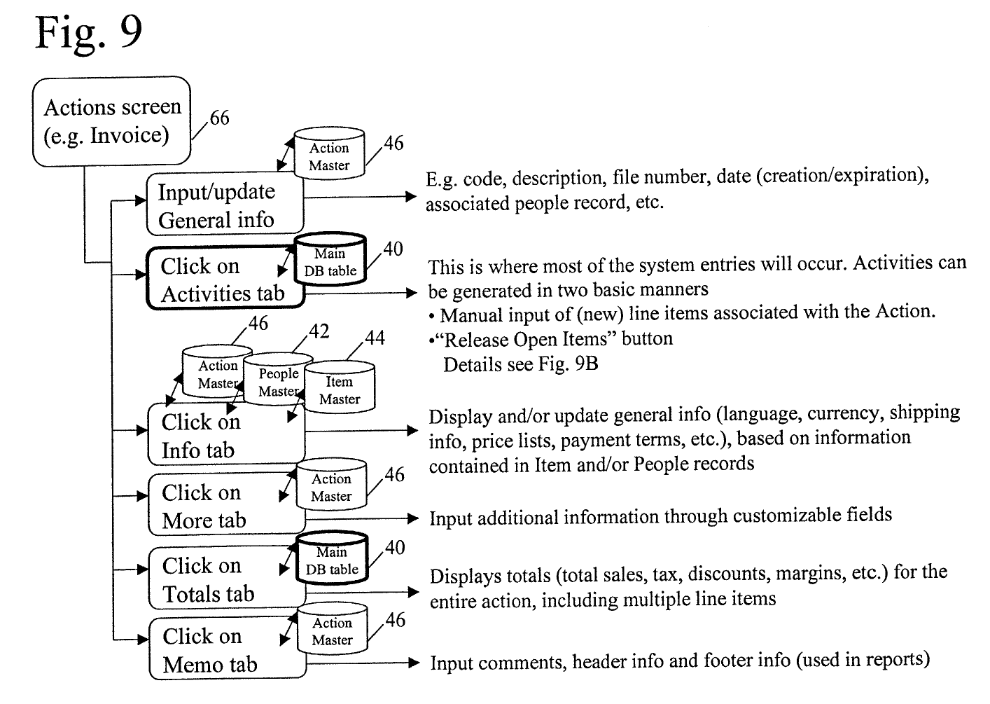

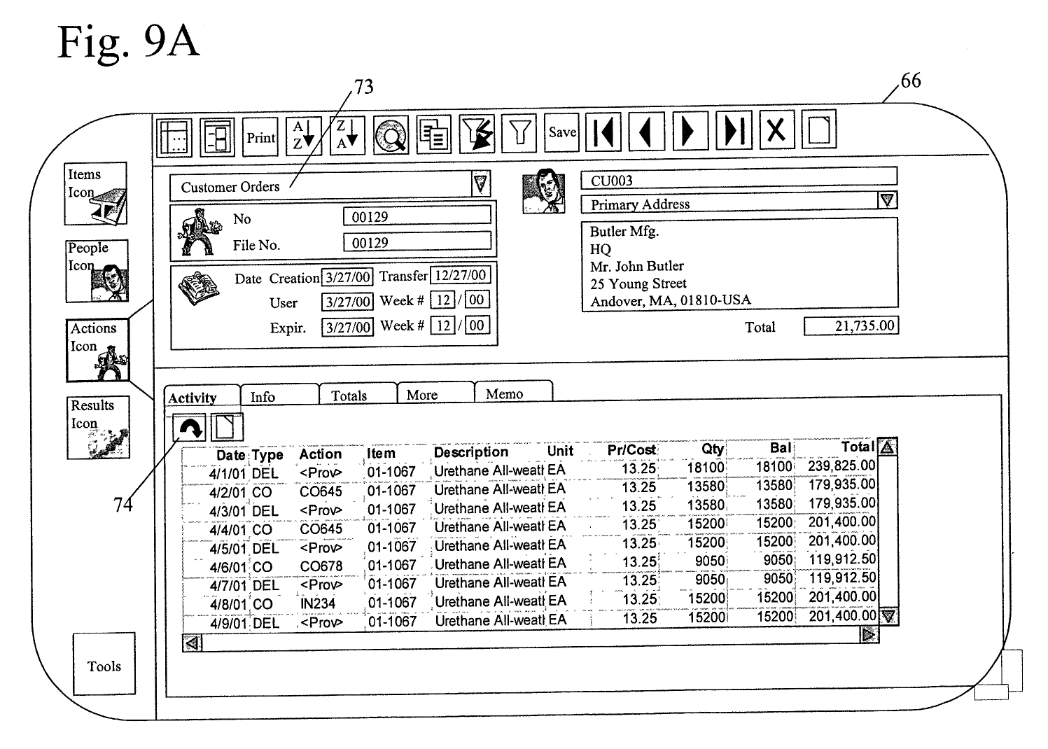

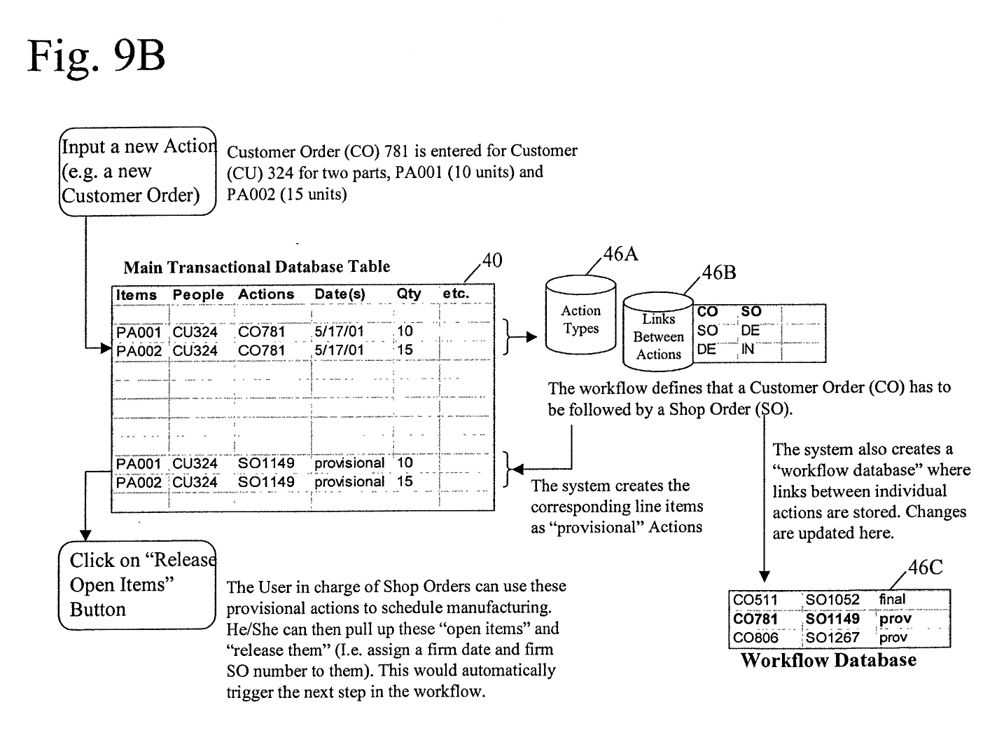

Referring again to FIG. 6, the Actions screen 66 allows the user to select a particular action type, e.g. invoice, and to input or select an action code, e.g. invoice code. FIG. 9 further illustrates the system flow chart in relation to Actions screen 66 and is to be considered together with FIG. 9A which illustrates a preferred form of Actions screen with a typical display that occurs when the Activity tab is selected. Actions selection is facilitated by providing as part of screen 66 a list of actions, e.g., customer orders, invoices, shipping documents, purchase orders, etc., that can be scrolled by clicking a scrolling bar as shown at 73. Otherwise the desired action can be selected by inputting its name or description e.g., Customer Orders, into a window located adjacent to the scrolling bar, as shown in FIG. 9a.

Action screen 66 provides the user a number of options. One option involves access to Action Master table 46 and permits the user to input or update general information pertaining to actions, e.g. action codes, descriptions, file number, date (creation/expiration), associated people record, etc. Such information is contained in a selected portion of the screen. Preferably, but not necessarily, as illustrated in FIG. 9A, this information is contained in the top portion of the screen.

Other options are provided by different tabs on Action screen 66. One option is an Activities tab. Clicking this tab accesses the main database table 40 and enables the user to enter information or instructions into the system. Activities are generated by manually inputting actions as line items in the main database 40, e.g., inputting of an order, purchase requisition, etc.

Alternatively, Actions can also be called into play by clicking a “Release Open Item” button 74 on Actions screen 66. This is only possible if two actions have been sequentially linked through a workflow. An example of such a workflow could be that customer deliveries have to be followed by invoices. In this example, clicking “Release Open Item” button 74 would bring up all “open deliveries” (i.e., deliveries for which no invoice has been issued yet), and the user could then release the item or items, i.e., generate the respective invoice.

The concept of workflow is further explained hereafter. A workflow represents a business process. It defines certain actions or activities, and it outlines what actions or activities are preceded or follow by which other actions or activities, under what conditions. In most businesses, workflows and business process are well known and often documented, whether in graphical form or in the form of manuals, procedures or guidelines. A business process or workflow can also be represented in the form of two related tables.

FIG. 9B is a graphical view of a business process constituting a workflow relating to customer orders that involves a number of actions and links between actions. In FIG. 9B, a customer order (CO) 781 is entered for customer (CU) 324 for ten units of part (PA) 001 and 15 units of part (PA) 002. The entry of that order into the main transactional data base using the Actions screen 66 involves accessing the Action Types database table 46A and Links Between Actions database table 46B to retrieve a work flow which requires that the customer order be followed by a Shop order (SO) to schedule manufacturing of the ordered parts. Based on this workflow, the system automatically creates corresponding line items in the main database 40 as provisional actions for the ordered parts. The person in charge of shop orders can subsequently click on a Release Items button to use the provisional actions to schedule manufacturing i.e. by issuing a shop order with a scheduled manufacturing date. Through this “pull” mechanism, the issued shop order will automatically trigger the next step in the workflow for the orders. The fact that the system creates provisional actions is an important feature of the invention, because it enables the software to plan manufacturing resources (often referred to as MRP). It also allows users to project future results, i.e., a manager can look at inventory values for a date in the past, in the present, but also in the future. The system stores all linked actions in the workflow database 46C. Any changes entered that affect the workflow, e.g, as per use of the Release Items button, are updated automatically in the workflow database for subsequent tracing of activity history.

On important benefit of this invention is the ability to potentially “delete” or “undo” an action. Given that the workflow database table 46C records all actions as well as their respective predecessor actions, the system can allow the user to “delete” an action and automatically restore the prior step in the workflow for the given items. An example would be deliveries that were shipped. The next step is to issue an invoice. If this invoice was issued erroneously, it could be “reversed”, and the deliveries could then be invoiced at a later stage (for example, in combination with other deliveries). This is a significant benefit for users that may be unfamiliar with the system or do not use it on an ongoing basis.

Actions screen 66 also presents additional options represented by “Info”, “Totals”, “More”, and “Memo” tabs. The Info tab accesses the Action Master table 46, People Master table 42 and Item Master table 44 for the purpose of displaying and/or updating general information (such as language, currency, shipping information, price lists, payment terms, etc.) based on the Item and People selected for this Action. The More tab accesses the Action Master table 46 and is used to input additional information through customizable fields. As a further option, see FIG. 9A, a “Totals” tab may be provided which when clicked will activate a computer program that tabulates totals, e.g., for a given Action such as CO 00129, all like items of this order are added and total sales, total cost, etc. are displayed for the entire order. Finally, the “Memo” tab allows the user to enter text and comments (these are stored in the Actions Master Table 46), which can be used in printing invoices or other documents related to this Action.

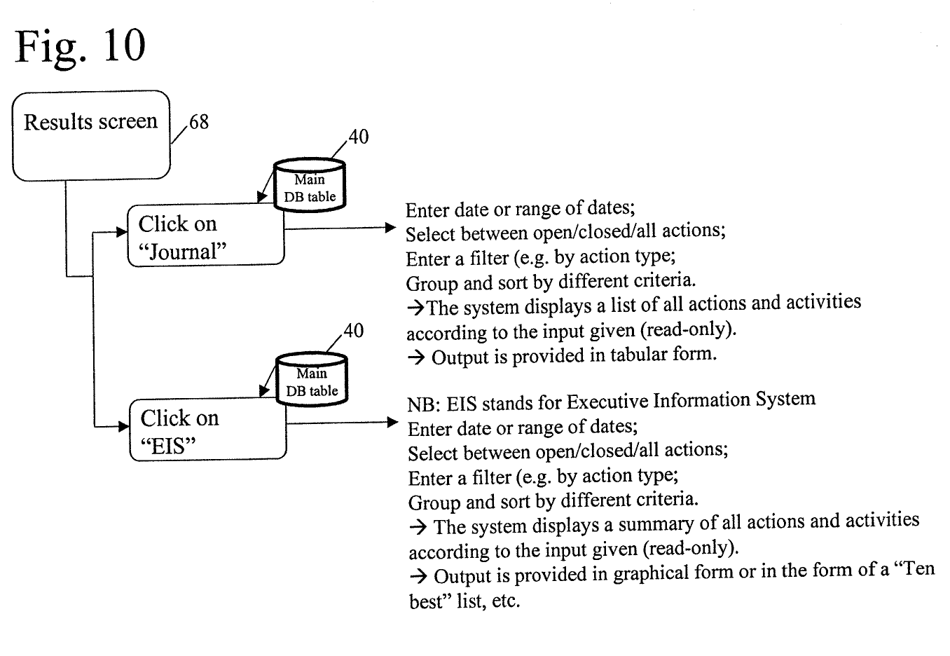

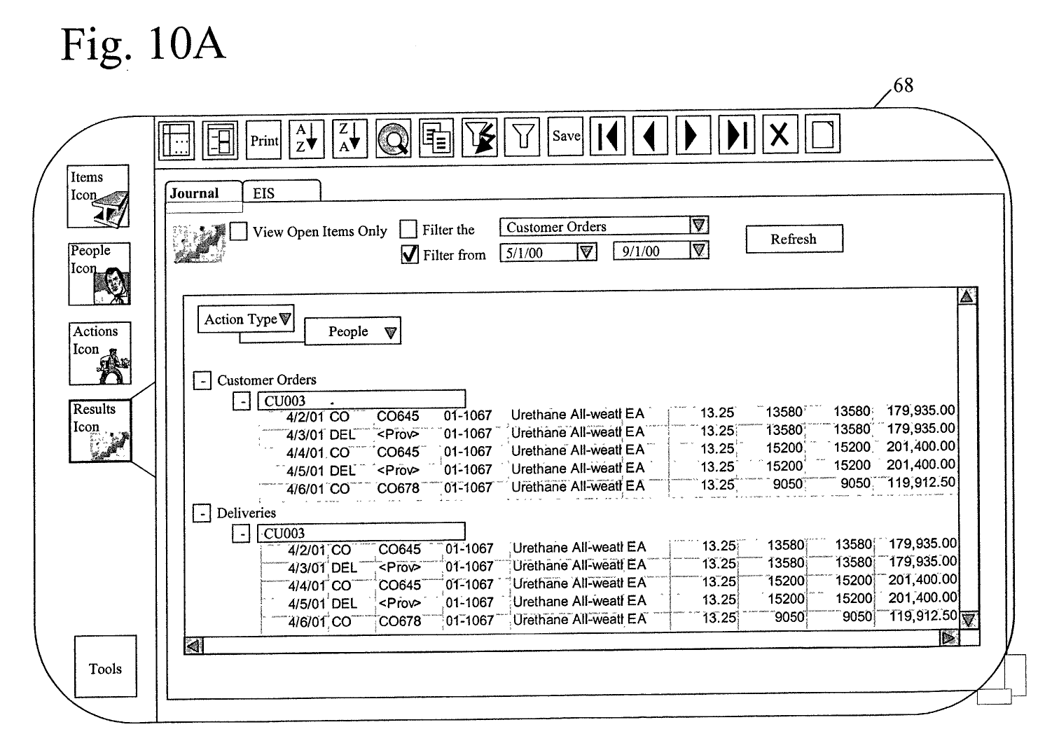

Referring again to FIG. 6 and also FIGS. 10 and 10A, selecting the Results screen 68 presents the user with two options in the form of tabs identified as Journal and EIS. FIG. 10A shows the Results screen 68 displaying information accessed via the Journal option. Selecting the Journal tab provides access to the main database table 40 and searching, sorting and filtering functions related to that database table that enable the user to access that database for the purpose of identifying and displaying a variety of transactions according to a given criteria. For example, by introducing a specific date or range of dates, the user may identify all transactions which occurred at that date or during that range of dates. The user may also enter a filter, e.g. by Action type or People type, to obtain a display of selected transactions. FIG. 10A illustrates the results of a search for orders from and deliveries to a customer identified by customer number CU 003 for the period from May 1, 2000 to Sep. 1, 2000.

Clicking on the EIS tab also accesses the main data base table 40. In this case, however, the program uses similar searching, sorting and filtering functions to summarize information from the main database table 40 in tabular, or graphical form (or some other suitable form such as, for example, a “ten best” list).

The high level of generic abstraction achieved by the four characteristics of Item, People, Action, and Time is a necessary pre-condition for the innovative use of a central transactional database containing those four elements, which in turn is a pre-condition, or at least an enabler, for use of the innovative and simplified graphical user interface constituting four screens representing Items, People, Actions and Results. A business application, however, needs to translate these generic characteristics into the real world descriptors. Items have to be identified, e.g., by part number and description, and classified, e.g, by function, size, material, color, etc. People have to be classified as suppliers, customers, re-sellers, employees, etc., while Actions have to be broken down into purchase orders, invoices, deliveries, payments, etc. Furthermore, links need to be established between actions. The foregoing requirements are met through the use, as noted above, of a generic, universally usable basic schema which defines data flows within the system. The integrated software system is literally driven from this central piece.

The basic schema essentially is created in a manner similar to the creation of a graph structure, i.e., by means of a configuration of points and lines joining the points. The data correspond to points and the links defining configurable operations between the data correspond to the lines between the points. The basic schema is created with the links being selected or determined out of the set of all possible links and their characteristics being specifically defined. This schema is implemented effectively by the use of two separate database tables, one defining the Action types and one defining the various Links between Actions. A basic schema as utilized in the present invention is in many ways analogous to the universal electrical substrate, e.g. a silicone chip. The design of a chip aims to link points with each other, defining certain operations between them. The data flow in the configured schema provided by this invention is analogous to power flow in an assembled universal electrical substrate. Thus the basic schema provided by this invention represents a universal platform for the design of certain work processes.

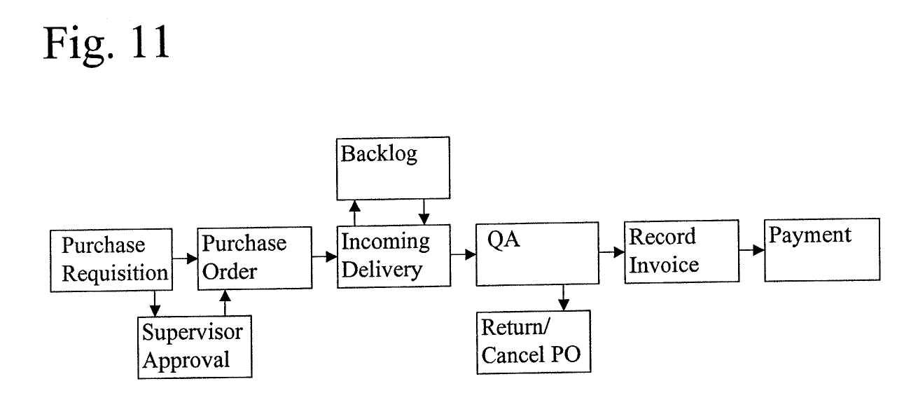

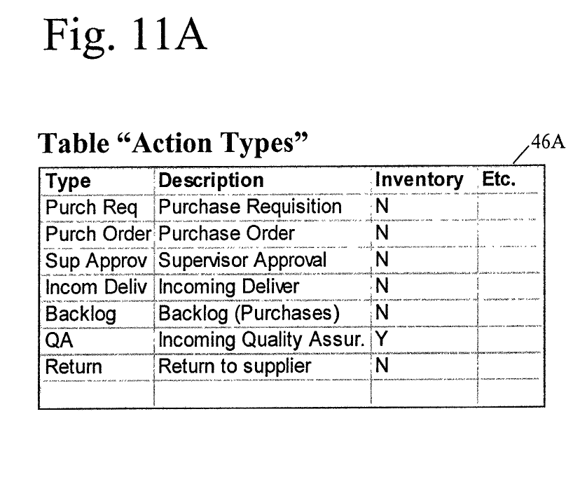

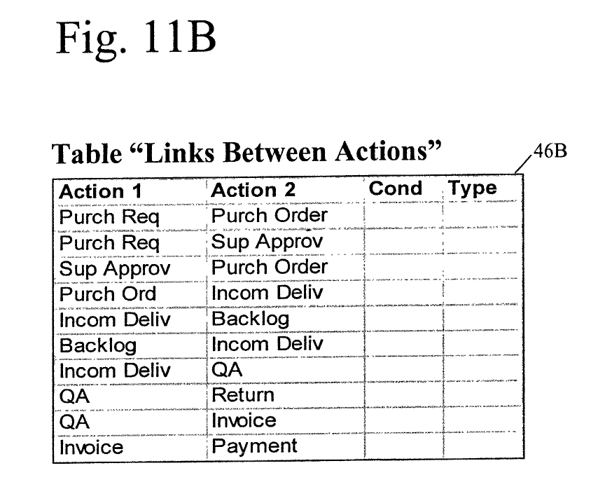

FIGS. 11, 11A and 11B illustrate an application of this basic schema to a series of business operations, or “workflow”. FIG. 11 is a graphical view of a conventional purchasing-of-goods business process. It is analogous to the graph structure of the basic schema referred to above, or to the layout of a silicone chip. The business process commences with a purchase requisition. That in turn results in issuance of a purchase order, with or without the need for prior supervisor approval of the requisition (which may depend on the amount of the purchase requisition). After issuance of the purchase order, the next step is the incoming delivery of the purchased goods. In the case where an order is for numerous items and only part of the order is filled, the backlog of undelivered goods is recorded in an incoming delivery processing log. The received goods are subject to quality approval, which in turn can result in return of goods and a cancellation of the purchase order, or acceptance of the received goods and approval of the invoice for later payment.

FIGS. 11A and 11B illustrates how the foregoing business process is handled by a system as herein disclosed. They are analogous to the table structure of the basic schema referred to above. The system has an Actions Type table 46A (FIG. 11A) and a Links Between Actions table 46B (FIG. 11B), the two tables together listing all actions and links between actions that are required to define the workflow for executing the business process shown in FIG. 11. As described above, the “Action Types” table defines the “points” of the basic schema, while the “Links Between Actions” table 46A defines the lines linking these points. The table 46A comprises separate action type entries for purchase requisition, purchase order, supervisor approval, etc., and allows the user to define these action types according to certain parameters, e.g., whether this action affects inventory or not. The Links Between Actions table 46B comprises separate entries for various action links. In FIG. 11B, actions are listed in two adjacent columns identified as Action 1 and Action 2. Each column lists specific actions, and it is to be understood that each action in the first column is linked to an action in the second column. Thus, for example, a link exists between the purchasing requisition action in the Action 1 column and the purchase order action in the Action 2 column. The further link that exists between a purchase requisition action and the necessary supervisor approval action is shown in FIG. 11B by repeating the purchase requisition designation in the Action 1 column and including a supervisor approval designation in the Action 2 column. The table 46B shown in FIG. 11B also indicates, by a comparison of Action 1 column entries and Action 2 column entries, that each action listed in the Action 2 column is linked to and follows an action listed in the Action 1 column. Thus the combination of the two tables illustrated in FIGS. 11A and 11B allow the representation of a graphical “many-to-many” relationship in tabular form. For example, the purchase order action, which is an essential part of the workflow for executing the business process of FIG. 11, is linked as follows: it is executed as a consequence of either purchase requisition or supervisor approval and dictates execution of the related incoming delivery action. Similarly the quality assurance action is executed in response to the incoming delivery action and it is linked to dictate execution of either the return action or the invoice action. It is believed that the action links represented by FIG. 11B are self evident in view of the preceding description. The “Links Between Actions” table of FIG. 11B also allows the user to define these links according to certain parameters. Thus, the user could define that a purchase requisition is to be followed by supervisor approval if the value is $1000 or more, but followed directly by a purchase order if the value is less than $1000.

Of course, the scheme illustrated in FIGS. 11A and 11B represent only one form of work flow that can be defined by actions and links between actions. Thus, instead of being a business process that is initiated by an internally generated purchase requisition, the workflow could relate to a company's sale of goods to a customer that is initiated by incoming orders for goods, in which case the business process would be similar to that illustrated in FIG. 9B, and would be executed by means of a programmed workflow that is defined by and comprises selected actions (e.g. enter customer order, approve customer credit status, approve acceptance of order, issue shop order, issue shipping order, prepare invoice, etc.) and selected links between actions (e.g., approve customer credit after entering customer order and accept customer order after customer credit approval) that establish the order of executing the selected actions and the conditions required to be met for each action to be executed.

One unique benefit of this basic workflow schema is that it is not patterned after a fixed pre-defined work process, but rather that any work processes whatsoever can be flexibly programmed into it, without the basic schema itself having to be modified. It has been determined that the neutral, universal structure of a workflow schema may be adequately implemented by approximately 100 rules or linkages. In comparison, for the representation of a workflow using a traditional business software application, use of as many as about 10,000 rules may be required. This is due to the fact the initial “points” to be linked already represent a high number, since traditional business software applications define customer orders, invoices, payments, quotes, returns, etc. all as clearly distinct “actions” in their system. Linking all these points in a possible workflow increase the number of possibilities exponentially. In essence, an excessive granularity has traditionally been used to record a workflow. Such a “detailed” structure becomes unwieldy and no longer transparent. As noted above, a supply of about 100 rules is adequate for the basic schema to represent workflow with adequate linkage for use. Naturally, a given business system according to the invention may add other rules, but even 150 or 200 rules has a negligible effect on the granularity in comparison to 10,000, thereby providing a significant advantage over traditional business software applications.

Providing an information handling system with a graphical user interface for navigating the system as herein described and illustrated achieves a number of benefits. For one thing, it allows companies to almost entirely eliminate user training. Users only have to learn the layout of four screens, rather than hundreds or thousands in traditional business software applications. Similar information is consistently located at the same place in the four basic screens of Items, People, Actions and Results, whether it is related to a customer or a vendor, or whether it is related to a purchase order or an invoice. It also significantly speeds up system navigation. If a user enters a customer order and needs to find out the inventory level of an item, the information is just a mouse click away rather than several menus up and down a menu tree, as is the case in traditional ERP applications. The four main icons not only represent real-world metaphors, they also represent different views and information requirements of different functions within the business. In this connection it should be noted that employees in sales, marketing, support, account receivable and account payable functions largely think and act along the people or customer dimension, and, therefore, will largely use the People screen. On the other hand, employees in product management, manufacturing, inventory, cost accounting and engineering think and act along the items dimension, and will therefore largely use the Items screen. Secretaries, clerical and operational people throughout the company initiate and perform transactions and will therefore, largely use the Actions screen. In contrast, managers and executives are results oriented and will largely use the Results screen. This focus of different functions within the company further simplifies the training requirements and navigational complexity.

It has to be pointed out that the user definable workflow technology is inherently linked to the other elements of the proposed invention, i.e. the simple four-screen graphical user interface and the main transactional database table. The latter two are based on the fundamental recognition that each business transaction can be represented at the most generic level by four characteristics: Item, People, Action, and Time. Given this high level of abstraction which is at the core of the proposed invention, a tool has to be provided to the user to take generic Actions and translate them into specific actions used in the business of the company. However, the user definable workflow technology is not only a requirement for the simple user interface and central database table—it also provides the user with a number of innovative benefits that no other business software application has been able to provide before. The workflow technology consists of a number of database tables, allowing users to define action types, to link action types logically, and to trace actual transactions at the line item level according to these defined linkages.

A further benefit of the workflow technology as defined herein is that it covers both external business processes (e.g. purchasing, sales, service, etc.) with internal business processes (e.g., manufacturing, bills of material, etc.). Therefore, no data is lost and the user has visibility over transactions affecting the entire enterprise with a very simple, easy-to-use tool.

While theoretically the simple user interface described above could be replicated for use with existing business software applications that employ a traditional database architecture based on a multitude of tables linked through numerous, often sequential relationships, in reality this would be very difficult if not impossible to accomplish successfully. With such a traditional database architecture, presenting the user with information in such a simple format would require highly complex aggregation of data in the background. This would either make the programming effort or the required hardware resources prohibitive, or it would significantly slow down the performance the user experiences in navigation and transaction processing.

The proposed database design also has another significant advantage. Information entered into the system by one person in the company is immediately reflected in the entire system. For example: If an order entry clerk enters an order from a customer via the Action screen, and a few minutes later a support engineer logs into the system via the People screen a telephone call from that same customer, the support engineer can see by accessing the People Screen Activity button that the customer has an open order outstanding. This advantage is difficult, if not impossible, to replicate by traditional business software applications using the database designs. This benefit can be illustrated with the analogy of a spreadsheet (such as Microsoft™ Excel) where the first four columns represent the key parameters discussed above in the order named (Items, People, Actions, and Time). Business transactions are entered into the spreadsheet as line items. The analogy of the Items screen is a sorting of the spreadsheet based on the first spreadsheet column. This would, for example, show all transactions associated with a given item. The analogy of the People screen is a sorting of the spreadsheet based on its second column. This would show all transactions associated with a given customer. If one new transaction (i.e., line item) is added, all cells of the spreadsheet (which may contain numerous formulas) are immediately updated. All sorting procedures are based on the same set of underlying data. Similarly, in a business software application according to the invention, all users are working with the same central transactional database, with different screens using different filters and sorting mechanisms (criteria).

The proposed invention further combines the definition of the workflow with a means to trace individual actions. This is achieved by means of a traceability database table (See FIG. 9B, table 46C) which essentially mirrors the main transactional database table. For each action entered into the system (at the line item level), the system reviews the workflow related tables (where action types and their linkages are defined), and records which follow-on action will have to be performed. The system also records additional information such as status, open balances, etc.

This innovation provides a complete audit trail of everything that has been going on within the company. To use the example of the workflow described in FIG. 11, each purchase requisition can be traced to the ultimate payment, and each payment from the cash register can be traced to the original purchase requisition. In essence, the proposed innovation includes an audit capability at the workflow level that allows companies to perform ISO 9000 audits based on their business software application. No traditional business software applications are known to record workflow related information at the level of an individual transaction. Recording workflow related information at a generic level has a significant drawback: A change in the process at a given date affects all transactions. It is very difficult, if not impossible, to maintain records pre- and post change. The invention solves this problem by including workflow related information at the level of each individual transaction record. To use an example: In February, a company may use a workflow whereby a Purchase Requisition is immediately followed by the issuance of a Purchase Order. Transactions recorded in February will reflect this workflow and can be traced accordingly. In March, the company changes its workflow to reflect the fact that Purchase Requisition above $1000 will require a “Supervisor Approval” before a Purchase Order can be issued. Transactions recorded from March onward will reflect this workflow and can be traced accordingly, without affecting earlier transactions.

It is believed evident that the invention as above described is capable of diverse uses and is capable of being tailored to accommodate all kinds of products, parts, assets, services, functions (e.g. banking, payment) and other resources, business and non-business organizations as well as real people, including but not limited to customers, prospects, vendors, suppliers, resellers, salesmen, distributors, employees, contractors, or transportation agents. Additionally, data output may be presented in various graphical, tabular or text forms, whether on screen, in a file, or in print. A further advantage is that the arrangement of components shown in FIGS. 2A and 2b may be varied. More specifically the specific form of computers and servers may be varied, and the locations where the applications software and user interface software are stored may be changed without departing from the essence of the invention. Still other advantages and modifications of the invention will be obvious to persons skilled in the art.

It is to be understood that the term “People” is used herein in a generic sense and is to be construed as embracing individual persons as well as business and other organizations, e.g., corporations, partnerships, governments and government agencies, and non-business institutions, and further that such entities may be vendors, contractors, customers, donors (e.g., in the case of adapting an information handling system embodying the invention for use by a charitable or educational institution), employees, employers, and the like.

What is claimed is:

1. A method of navigating a business application software using a computer system having a central processing unit, a display device coupled to said central processing unit, and a transactional database containing business information according to the dimensions of Items, People, Actions and Time, said method comprising:
simultaneously displaying icons on said display device separately representing the categories of Items, People, Actions, and Results;
accessing through any of said icons information contained in the software application or said database which is related to the category represented by said any icon; and
displaying the accessed information via a screen display specific to the said any icon.

2. A method according to claim 1 wherein said icons are displayed on a substantially continuous basis.

3. A method according to claim 1 comprising accessing and/or altering through the Items icon any information contained in the software application or said database which is related to selected physical or nonphysical elements, including but not limited to products, parts, assets, services and other physical or non-physical resources.

4. A method according to claim 1, comprising accessing and/or altering through the People icon any information contained in the software application or said database which is related to real people, including but not limited to customers, prospects, vendors, suppliers, employees, contractors, or transportation agents.

5. A method according to claim 1, comprising accessing and/or altering through the Actions icon any information contained in the software application or its database which is related to activities performed within an organization or between the organization and its external business partners, including but not limited to quotations, orders, picks, invoices, credit checks, and return authorizations.

6. A method according to claim 1, comprising accessing through the Results icon summaries of data contained in the software application or its database, whether in graphical, tabular or text form, whether on screen, on a file, or in print.

7. A method of simplifying interaction between a user and a computer system having a central processing unit coupled to a display device and a transactional database containing data representative of the dimensions items, people, actions and time, said method comprising:
simultaneously displaying icons on said display device representing items, people, actions, and results;
accessing and/or altering through any of said icons any data contained in the database which is related to the dimensions represented by said any icon; and
displaying the accessed and altered data via a screen display specific to the dimension identified by said any icon.

8. An information handling apparatus comprising:
a computer system having a central processing unit and a display device coupled to said central processing unit;
a transactional database containing, on a line item basis, data in at least the following dimensions: items, people, actions and time; and
a graphical user interface coupled to said computer system comprising (a) means for causing said display device to display icons representing the dimensions of items, people, actions and results, (b) means for accessing through any one of said icons data contained in said database, and (c) means for managing the accessed data according to algorithms contained in the software and workflows defined by the user.

9. An information handling apparatus comprising:
a computer system having a central processing unit and a display device coupled to said central processing unit;
a transactional database containing, on a line item basis, data in at least the following dimensions: items, people, actions and time; and
a graphical user interface coupled to said computer system comprising (a) means for causing said display device to display icons representing the dimensions of items, people, actions and results, and (b) means operative through selection of any of said icons for accessing data contained in said database and managing the accessed data according to specific workflows related to the dimension represented by said any icon.

10. An information handling apparatus comprising:
a central processing unit;
a display device coupled to said central processing unit;
a transactional data base coupled to said central processing unit for storing data relating to at least items, people, actions and time on a line item basis;
software defining a scheme for managing and processing said data and for generating results according to selected workflows; and
a graphical user interface characterized by (1) means for causing said displace device to display separate icons as metaphors for items, people, actions and results and to generate separate screens for use in accessing and processing data on the basis of items, people, actions and results, and (2) means for causing said software to display data according to said scheme on the basis of items, people, actions or results,

11. An information handling apparatus comprising:
a computer system having a central processing unit and a display device coupled to said central processing unit;
a transactional database containing, on a line item basis, data in at least the following dimensions: items, people, actions and time; and
a graphical user interface coupled to said computer system comprising (a) means for causing said display device to display icons representing items, people, actions and results, and (b) means responsive to selection of any of said icons for accessing specific software and managing and processing data contained in said database according to said accessed specific software.

12. An information handling apparatus according to claim 11 wherein said specific software defines a workflow.

13. An information handling apparatus according to claim 12 wherein said specific software comprises a first database table that defines types of actions to be executed by said computer system and a second database table that defines possible links between said action types.

14. An information handling apparatus according to claim 13 wherein said specific software comprises a third database table that contains a record of links between actions that have been executed or are planned for execution.

15. An information handling apparatus comprising:
a computer system having a central processing unit and a display device coupled to said central processing unit;
a transactional database containing, on a line item basis, data in at least the following dimensions: items, people, actions and time; and
a graphical user interface coupled to said computer system comprising (a) means for causing said display device to display icons representing items, people, actions and results, and (b) software defining a schema for managing data contained in said database according to specific workflows accessed by selection of one of said icons.

16. A graphical user interface for accessing data stored in a computer system that includes a display device, said interface comprising (a) means for causing said display device to display icons representing the dimensions of items, people, actions and results, (b) means for accessing through any one of said icons data contained in said database, and (c) means for managing the accessed data.

17. A graphical user interface according to claim 16 wherein said graphical user interface is adapted to provide four separate screens, one each for Items, People, Actions and Results, with each of said screens displaying all of said icons.

18. A graphical user interface according to claim 17 wherein each of said screens includes one or more tabs or buttons that represent options available to the user with respect to accessing or processing data.

19. An information handling apparatus comprising:
a computer system having a central processing unit and a display device coupled to said central processing unit;
a transactional database containing, on a line item basis, data in at least the following dimensions: items, people, actions and time; and
a schema involving user-defined actions and links between actions for managing data contained in said database according to specific workflows.

20. A method of defining a workflow in a computer system comprising establishing a first database table that lists and defines different action types a second database table that lists and defines possible links between action types, and a third database table that maintains a record of the links between actual actions as they have occurred or as they are planned to occur.

21. A method according to claim 20 wherein said links establish the order of executing selected actions and/or the conditions to be met for an action to be executed.

22. A method according to claim 20 wherein said action types include a purchase requisition action and a purchase order action, and said second database table contains a link between said purchase requisition action and said purchase order action that establishes the order of executing those actions.

23. A method according to claim 20 wherein said action types include a customer order action, an approved acceptance of order action, an issue shipping order action, and an issue invoice action, and said second database table contains separate and specific links between action types that establish the order of executing said action types and/or the conditions to be met for each action type to be executed.
